(19) United States
(12) Patent Application Publication
(10) Pub. No.: US 2024/0173887 A1
(43) Pub. Date: May 30, 2024

(54) ULTRA-FAST SINTERING METHOD AND SINTERING SYSTEM FOR PREPARING NANO-CERAMICS BY ULTRASOUND-ASSISTED PRESSURIZATION COUPLED WITH HIGH FREQUENCY INDUCTION

(71) Applicant: QILU UNIVERSITY OF TECHNOLOGY, Jinan (CN)

(72) Inventors: Mingdong Yi, Jinan (CN); Gang Xue, Jinan (CN); Wenjie Liu, Jinan (CN); Kaining Liu, Jinan (CN); Wen Zhang, Jinan (CN); Yuchen Xu, Jinan (CN); Chenyang Yi, Jinan (CN); Chonghai Xu, Jinan (CN)

(73) Assignee: QILU UNIVERSITY OF TECHNOLOGY, Jinan (CN)

(21) Appl. No.: 18/353,919

(22) Filed: Jul. 18, 2023

(30) Foreign Application Priority Data
Nov. 18, 2022 (CN) 202211443346.X

(51) Int. Cl. B28B 3/02; B28B 17/00; B30B 11/02; C04B 41/00

(52) U.S. Cl. CPC B28B 3/022; B28B 17/0081; B30B 11/022; C04B 41/0072; C04B 2235/5454; C04B 2235/604; C04B 2235/66

(57) ABSTRACT

An ultra-fast sintering method and a sintering system for preparing nano-ceramics by ultrasonic-assisted pressurization and high-frequency induction, it belongs to the technical field of nano-ceramics sintering; this method mainly aims at the problem that nano-ceramics are easy to grow during sintering, and develops an ultrasonic-assisted pressurized coupled high-frequency induction sintering system to prepare nano-ceramic materials; in the process of sintering, ultrasonic wave is used to form high frequency, alternating impact and cavitation on nano-ceramic particles, which can quickly exhaust the gas between particles and inhibit the agglomeration of nano-ceramic particles; on the other hand, the rapid sintering of nano-ceramics is realized by using the principle of high-frequency induction to instantaneously heat the graphite mold and generate a lot of heat.

### CROSS-REFERENCE TO RELATED APPLICATIONS

This application claims priority to Chinese Patent Application Ser. No. CN202211443346X filed on 18 Nov. 2022.

### TECHNICAL FIELD

The invention relates to an ultra-fast sintering method and a sintering system for preparing nano-ceramics by ultrasonic-assisted pressurization and high-frequency induction, and belongs to the technical field of nano-ceramics sintering.

### BACKGROUND OF THE INVENTION

Ceramic materials play an important role in daily life, industrial production and national defense, but the traditional ceramic materials are brittle, poor in toughness and strength, which greatly limits their application scope. With the wide application of nanotechnology, ceramic materials prepared with nano-ceramic powder can effectively reduce the defects on the surface of the material and obtain a uniform and smooth surface; Can enhance the interfacial activity and improve the single crystal strength of the material; It can effectively reduce stress concentration, reduce wear and effectively improve the toughness of ceramic materials, so that nano-ceramics have the same flexibility and machinability as metals. Nano-ceramic materials are advanced engineering materials with unique properties, and their applications have undoubtedly attracted more and more attention.

Sintering is the process of ceramics densification, grain boundary formation and grain growth, and it is the key step to prepare nano-ceramic materials. Only by sintering nano-powder into nano-ceramic materials, can the excellent characteristics of nano-ceramics be reflected. Nano-powder has strong adsorption, which will bring in too many air magazines and serious agglomeration. These characteristics make the sintering of nano-ceramic powder difficult to control.

Because of its small temperature gradient, slow heating rate and long sintering time, conventional sintering methods often make nano-ceramic grains grow rapidly, and the grain size after sintering is much larger than the original grain size of powder, thus failing to achieve the characteristics of nano-ceramics. Therefore, controlling the grain growth during sintering is one of the keys to the commercial success of nano-ceramic materials. Hot-pressing sintering is a sintering process with a certain external pressure at the same time. If there is a chemical reaction in the sintering process, it is called reactive hot-pressing sintering. This sintering method uses relatively high pressure to make the large gaps of the material collapse and form closed-cell gaps, so that the agglomerated nano-powder can be sintered into dense nanocrystalline ceramic materials, but its sintering time is too long and the equipment is complicated, which greatly increases the cost. Spark plasma sintering (SPS) can activate the surface of each particle in the sample and heat itself by using the high-temperature instantaneous discharge plasma generated by pulse energy, Joule heat and discharge pulse pressure, which can achieve fast heating speed and short sintering time, but in the application of sintering nano-ceramic powder, it is still unable to inhibit the grain growth and make it stay in nano-size; Rapid pressureless sintering heats the ceramic powder body with the fastest heating rate, and directly raises it to a higher sintering temperature, which can achieve the effect of long grains in the early stage of microstructure and limit the number of grains growing. However, studies have confirmed that for samples with poor thermal conductivity or large body size, a thermal gradient will be generated in the sample under the condition of rapid pressureless sintering, which leads to the phenomenon that the heat has not yet reached the inside of the sample and the outside of the sample has hardened, and finally the densification of the sample is suppressed. Microwave sintering is a new rapid sintering method, which uses microwave special band to couple it with the fine structure of materials to generate heat to realize densification. At present, ceramic materials such as Al₂O₃ and ZrO₂ have been successfully sintered by this technology, however, the performance index of microwave sintered nano-ceramics has not reached the best in theory, and the interaction theory between microwave materials is not perfect and the development of new microwave equipment is slow, which limits its further development.

High-frequency induction heating belongs to non-contact heating, and its heating process includes the energy transfer of electric energy to the workpiece through electromagnetic induction phenomenon and the energy conversion of electric energy into heat energy due to the thermal effect of current, which has many advantages such as fast heating speed, high efficiency, good working environment, energy saving and environmental protection. Studies have confirmed that high-frequency induction heating sintering method can sinter and densify materials in a very short time, which can not only effectively achieve rapid densification to near theoretical density, but also inhibit the grain growth of nano-structured materials, which can meet the requirements of inhibiting the grain growth of nano-ceramics. However, the density distribution inside the sintered powder is often uneven, which leads to the inconsistent shrinkage rate of the green body during sintering, uneven thickness of the sample, and even microcracks and cracks, thus affecting the properties of the material.

The research shows that if the pressed material is vibrated during the powder pressing process, the density uniformity inside the powder can be improved, but the general mechanical vibration is difficult to keep up with the speed of high-frequency induction heating, and the amplitude of mechanical vibration is large, so the center of gravity is easy to shift during sintering, which affects the performance and strength of the finished powder.

### SUMMARY OF THE INVENTION

Aiming at the shortcomings of the prior art, the invention provides an ultra-fast sintering method and a sintering system for preparing nano-ceramics by ultrasonic-assisted pressurization coupled with high-frequency induction, which can not only effectively improve the density and hardness of the compact, but also reduce the friction between powder particles and between powder particles and the die wall, improve the density uniformity of the powder compact, and thus improve the performance and strength of the powder finished product.

The invention adopts the following technical scheme:

An ultra-fast sintering method for preparing nano-ceramics by ultrasonic-assisted pressurized coupling high-frequency induction comprises the following three steps:
(1) Ultrasonic-assisted cold pressing stage: apply uniaxial pressure, and start the ultrasonic vibration system to precompress the powder to discharge most of the gas. Starting the ultrasonic vibration at this stage can effectively improve the density distribution uniformity of the powder compact;
(2) heating stage: with high-frequency induction heating, the graphite mold generates strong heat by itself under the action of high-frequency induction; Ultrasonic vibration makes the surface atoms of single nanoparticles vibrate and impact, promotes the surface activation and homogenization of nanoparticles, inhibits agglomeration and accelerates densification;
(3) Heat preservation stage: after the sintering temperature is reached, the ultrasonic wave stops, the sintering of nano-ceramic grains is promoted by the heat of the graphite mold, and the densification of nano-ceramic materials is realized along with the growth of the grains, thus improving the mechanical properties of nano-ceramics.

An ultra-fast sintering system for preparing nano-ceramics by ultrasonic-assisted pressurization and high-frequency induction comprises a high-frequency induction heating system, a hydraulic lifting system and an ultrasonic vibration system, wherein the high-frequency induction heating system comprises a high-frequency induction coil and a high-frequency induction heater, which can meet the sintering requirements of various nano-ceramic materials, and the frequency induction heater is connected with the high-frequency induction coil to provide power for the high-frequency induction coil;

The hydraulic lifting system comprises a hydraulic press, an upper beam and a middle beam, wherein the upper beam is fixed on the hydraulic press, and the middle beam can lift tip and down relative to the hydraulic press; a working platform and a sintering mold are sequentially arranged on the middle beam; the hydraulic lifting system provides pressure for a processed workpiece in the sintering mold; and a high-frequency induction coil is arranged outside the sintering mold;

The ultrasonic vibration system comprises an ultrasonic generator, a transducer and an amplitude transformer, and is used for applying ultrasonic vibration in the sintering process to inhibit the agglomeration of nano-ceramic powder.

Preferably, the sintering mold comprises an upper press head, a lower press head and an external graphite mold, wherein the upper press head, the lower press head and the graphite mold form a cavity, and the cavity is used for loading powder.

Preferably, the working platform is a cylindrical hollow structure, the hollow structure is used for placing an amplitude transformer, and the amplitude transformer provides vibration pulse pressure for the workpiece; a groove is arranged above the working platform, and the graphite mold is placed in the groove, and the groove is in clearance fit with the graphite mold, so that the lateral displacement of the graphite mold can be limited in the pressing process.

The working platform is specially designed according to the size of the die and the horn, and is used to place the sintering die and limit its lateral displacement during the pressing process.

Preferably, the ultrasonic vibration system is arranged in the cavity at the lower part of the working platform, the lower end of the horn is connected with the ultrasonic transducer to form an integrated structure, the whole horn passes through the cavity in the middle of the working platform, and its upper end is in direct contact with the lower pressure head to ensure that the pulse pressure can be transmitted to the powder through the lower pressure head; The ultrasonic transduce and that horn are arranged right below the work platform, and the axes of the ultrasonic transducer and the horn coincide with the axes of the sinter die.

Preferably, the hydraulic lifting system is controlled by computer software. By controlling the lifting of the middle beam, the pressure is adjusted, and the mold is pressurized, maintained and relieved, so that the powder between the upper head and the lower head is gradually densified by the pressure; A sensor is arranged below the working platform, and the sensor is fixed on the middle cross beam by hexagonal bolts; The lower part of the working platform is provided with a section of external thread, and the through hole in the middle cross beam is provided with a section of internal thread, and the two are fixed by thread matching; The sensor includes displacement sensor and pressure sensor, both of which are directly connected to the computer. The changes of pressure and displacement can be recorded in real time by software, and the sintering displacement curve can be obtained.

Preferably, an infrared thermometer is arranged outside the sintering mold and connected to a computer to record the surface temperature of the sintering mold in real time.

Preferably, the input voltage of the high-frequency induction heater is 220V and the power is 0˜50 kW;

The inner diameter of the high-frequency induction coil is 80 mm, the height is 40 mm, and the number of turns of the coil is 4 turns. It is directly connected to the output port of the high-frequency induction heater and screwed with bolts.

The high-frequency induction coil has a hollow structure and is communicated with the water cooling circulating guide in the high-frequency induction heater, which can prevent the machine from idling due to overheating of the equipment in the working process;

Further preferably, the high-frequency induction heater is placed behind the hydraulic press, and the cabinet of the high-frequency induction heater is provided with an electric control device, which can set heating time, heat preservation time, heating power and heat preservation power, and control buttons and knobs are arranged on the surface of the cabinet; At the same time, the high-frequency induction heater is provided with an automatic mode and a manual mode, wherein the automatic mode is automatically operated according to the set heating time and holding time, and the manual mode is controlled by a foot switch.

Further preferably, the ultrasonic generator is placed on the upper floor of the base of the hydraulic lifting system, and the input end of the transducer is connected with the output end of the ultrasonic generator. The ultrasonic generator rectifies and filters 220V and 50/60 Hz power frequency alternating current into 310V direct current, which is chopped into a specific high-frequency alternating current, and then the signal is amplified to several thousand volts of high-voltage alternating current to drive the transducer to generate resonance at its own resonance point.

The frequency of the transducer is 20˜28 kHz, and the power is 1200˜2000W. After receiving the current signal of the ultrasonic generator and generating resonance, the amplitude transformer connected with it amplifies the particle displacement or speed of mechanical vibration and concentrates the ultrasonic energy in a small area. The transducer and the horn are in an integrated structure and are matched by bolts;

The bottom of the transducer is provided with a clamping device which can adjust and fix the height of the transducer.

Furthermore, the clamping device is sleeved on the transducer after the handle is installed through a ring-shaped sleeve, and the sleeve can be tightened by bolts, thereby fixing the position of the transducer.

The invention relates to a method for sintering and forming nano-ceramic powder based on an ultra-fast sintering system for preparing nano-ceramics by ultrasonic-assisted pressure coupling high-frequency induction, which comprises the following steps:
1) Dispersion of nano-powder: adding nano-ceramic powder into a beaker containing 200 ml absolute ethanol, ultrasonically dispersing and stirring for 30 min to obtain a uniformly dispersed solution, then taking cemented carbide balls with 10 times the mass of the mixture, pouring them into a ball milling tank, filling them with nitrogen, ball milling for 48 h, drying the ball milled solution in a vacuum drying oven at 120° C. for 24 h, and sieving with 200 meshes to obtain nano-powder for sintering;
2) charging: sequentially placing a lower press head, nano powder and an upper press head in a graphite mold, and placing graphite gaskets between the nano powder, the graphite mold and the inner surface of the press head to prevent the powder from leaking during the pressing process, and then placing the prepared sintering mold on the working platform of the middle cross beam;
3) Ultrasonic-assisted cold pressing: the computer controls the beam in the hydraulic lifting system to rise to the position where the upper pressure head just touches the upper beam, then the transducer and the horn are installed, connected to the ultrasonic generator and connected with the power supply, and finally passed through the cavity of the working platform, and the horn is fixed to the position where it is in close contact with the lower pressure head by a clamping device; Start the ultrasonic vibration system, and set the fierce of 5-10 MPa in the software for 1 Amin. At this stage, ultrasonic vibration is used to promote the flow rearrangement of powder particles and exhaust the gas between particles; After the preloading time is over, gradually increase the pressure to the required value and then keep it constant; In this process, the pressure exerted by the beam is accurately controlled by software, and the computer can record the shrinkage displacement of sintered powder in real time.
4) Heating up: start the high-frequency induction heating system (power is set according to the sintered powder), heat up to the pre-sintering temperature (temperature is set according to the sintered powder), after the pre-sintering stage is completed, start the ultrasonic vibration system, set the frequency to 80%, and increase the high-frequency power to the specified value, so as to reach the final sintering temperature;
5) heat preservation: turning off the ultrasonic vibration system after reaching the final sintering temperature; Using the heat of graphite mold to promote the sintering of nano-ceramic grains, and realize the densification of nano-ceramic materials with the growth of grains;
6) cooling: after observing that the displacement curve in the software does not continue to rise, the high-frequency induction heating system is turned off to stop sintering, so that the graphite mold is naturally cooled to room temperature, and the sintered sample is taken out, and then the relevant mechanical properties are tested.

Where the invention is not detailed, the prior art can be adopted.

The invention has the beneficial effects that:
(1) According to the invention, ultrasonic-assisted pressure sintering of nano-ceramic materials is utilized, and the activation effect of ultrasonic vibration on nano-particles is utilized to accelerate atomic diffusion and interfacial mass transfer, thus solving the problems of uneven microstructure, easy growth of nano-ceramic grains and the like caused by differential sintering of inner and outer layers when high-frequency induction sintering is adopted alone.
(2) The invention proposes, designs and develops an ultrasonic-assisted pressurized coupled high-frequency induction sintering system, and the related research has not been reported at home and abroad, which has remarkable innovation.
(3) Guided by practical application, the invention refines and homogenizes the microstructure of nano-ceramic materials by developing an ultrasonic-assisted pressurized coupled high-frequency induction sintering system, develops high-performance nano-ceramic materials, and forms a typical method combining sintering system research and development with nano-ceramic microstructure optimization.

### BRIEF DESCRIPTION OF DRAWINGS

FIG. 1 is a schematic diagram of the three-dimensional structure of the sintering system of the present invention;

FIG. 2 is a schematic structural diagram of the hydraulic lifting system of the sintering system of the present invention;

FIG. 3 is a sectional view of FIG. 2;

FIG. 4 is a schematic structural diagram of the working platform of the present invention;

FIG. 5a is a scanning electron microscope image of a standard tool sample, in which is the cross-sectional microstructure of the sample obtained in Experiment A;

FIG. 5b is a scanning electron microscope image of a standard tool sample, in which is the cross-sectional microstructure of the sample obtained in Experiment B;

Wherein: 1—high-frequency induction heater, 2—high-frequency induction coil, 3—hydraulic press, 4—infrared thermometer, 5—clamping device, 6—ultrasonic generator, 7—upper beam, 8—working platform, 9—middle beam, 10—transducer and horn, 11—graphite mold, 12—sensor, 13—Upper pressure head and 14—Lower pressure head.

### DETAILED DESCRIPTION OF THE INVENTION

In order to make the technical problems, technical solutions and advantages to be solved by the present invention more clear, the following will be described in detail with the attached drawings and specific embodiments, but it is not limited to this. Anything not described in detail in the present invention shall follow the conventional technology in this field.

### Example 1

An ultra-fast sintering method for preparing nano-ceramics by ultrasonic-assisted pressurized coupling high-frequency induction comprises the following three steps:
(1) Ultrasonic-assisted cold pressing stage: apply uniaxial pressure, and start the ultrasonic vibration system to precompress the powder to discharge most of the gas. Starting the ultrasonic vibration at this stage can effectively improve the density distribution uniformity of the powder compact;
(2) heating stage: with high-frequency induction heating, the graphite mold generates strong heat by itself under the action of high-frequency induction; Ultrasonic vibration makes the surface atoms of single nanoparticles vibrate and impact, promotes the surface activation and homogenization of nanoparticles, inhibits agglomeration and accelerates densification;
(3) Heat preservation stage: after the sintering temperature is reached, the ultrasonic wave stops, the sintering of nano-ceramic grains is promoted by the heat of the graphite mold, and the densification of nano-ceramic materials is realized along with the growth of the grains, thus improving the mechanical properties of nano-ceramics.

### Example 2

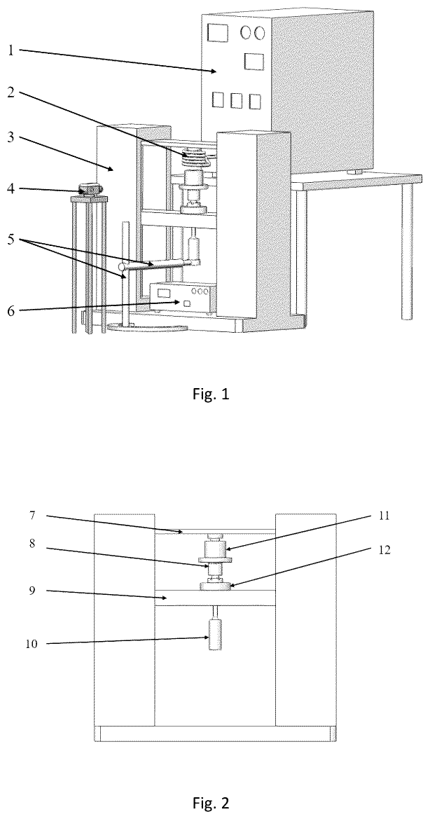

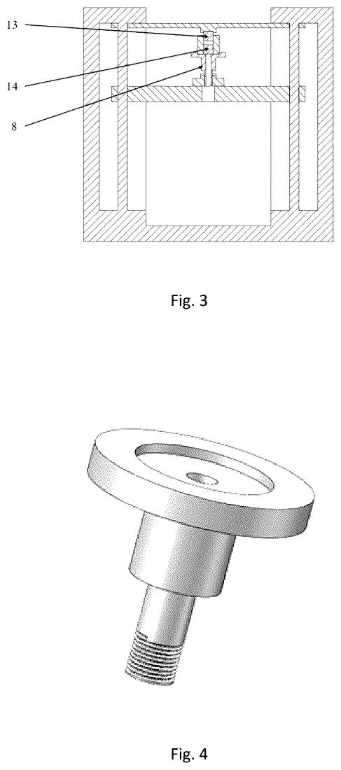

As shown in FIG. 1-4, an ultra-fast sintering system for preparing nano-ceramics by ultrasonic-assisted pressurization and high-frequency induction comprises a high-frequency induction heating system, a hydraulic lifting system and an ultrasonic vibration system, wherein the high-frequency induction heating system comprises a high-frequency induction coil 2 and a high-frequency induction heater 1, which can meet the sintering requirements of various nano-ceramic materials, and the frequency induction heater 1 is connected with the high-frequency induction coil 2 to provide power for the high-frequency induction coil 2;

The hydraulic lifting system comprises a hydraulic press 3, an upper cross beam 7 and a middle cross beam 9, wherein the upper cross beam 7 is fixed on the hydraulic press 3, and the middle cross beam 9 can lift up and down relative to the hydraulic press 3; the middle cross beam 9 is sequentially provided with a working platform 8 and a sintering mold; the hydraulic lifting system provides pressure for a workpiece to be processed in the sintering mold; and the high-frequency induction coil 2 is arranged outside the sintering mold;

The ultrasonic vibration system includes an ultrasonic generator 6, a transducer and a horn 10, which is used to apply ultrasonic vibration in the sintering process and can inhibit the agglomeration of nano-ceramic powder.

### Example 3

An ultra-fast sintering system for preparing nano-ceramics by ultrasonic-assisted pressurization coupled with high-frequency induction is described in Embodiment 2, but the difference is that the sintering mold includes an upper ram 13, a lower ram 14 and an external graphite mold 11, and the upper ram 13, the lower ram 14 and the graphite mold 11 form a cavity for loading powder.

The working platform 8 has a cylindrical hollow structure, and the hollow structure is used for placing the horn, which provides vibration pulse pressure for the workpiece. A groove is arranged above the working platform 8, and the graphite mold is placed in the groove. The groove and the graphite mold are in clearance fit, which can limit the lateral displacement of the graphite mold in the pressing process.

The working platform is specially designed according to the size of the die and the horn, and is used to place the sintering die and limit its lateral displacement during the pressing process.

### Example 4

An ultra-fast sintering system for preparing nano-ceramics by ultrasonic-assisted pressure coupling and high-frequency induction, as described in Embodiment 3, is different in that the ultrasonic vibration system is arranged in the cavity at the lower part of the working platform, the lower end of the horn is connected with the ultrasonic transducer to form an integrated structure, the whole horn passes through the cavity in the middle of the working platform, and its upper end directly contacts with the lower pressure head 14 to ensure that the pulse pressure can be transmitted to the powder through the lower pressure head; The ultrasonic transduce and that horn are arranged right below the work platform, and the axes of the ultrasonic transducer and the horn coincide with the axes of the sinter die.

### Example 5

An ultra-fast sintering system for preparing nano-ceramics by ultrasonic-assisted pressurization coupled with high-frequency induction is as described in Embodiment 4. The difference is that the hydraulic lifting system is controlled by computer software. By controlling the lifting of the middle beam 9 and adjusting the pressure, the sintering mold is pressurized, maintained and relieved, and the powder between the upper ram 13 and the lower ram 14 is gradually densified by the pressure. A sensor 12 is arranged below the working platform 8, and the sensor 12 is fixed on the middle cross beam by hexagonal bolts; The lower part of the working platform is provided with a section of external thread, and the through hole in the middle cross beam is provided with a section of internal thread, and the two are fixed by thread matching; The sensor 12 includes a displacement sensor and a pressure sensor, both of which are directly connected to the computer, and the changes of pressure and displacement can be recorded in real time through software to obtain the sintering displacement curve.

### Example 6

An ultra-fast sintering system for preparing nano-ceramics by ultrasonic-assisted pressurization coupled with high-frequency induction is described in Embodiment 5, except that an infrared thermometer 4 is arranged outside the sintering mold and connected to a computer to record the surface temperature of the sintering mold in real time.

### Example 7

An ultra-fast sintering system for preparing nano-ceramics by ultrasonic-assisted pressure coupling and high-frequency induction is described in Embodiment 6, except that the input voltage of high-frequency induction heater 1 is 220V and the power is 0-50 kW;

The high-frequency induction coil 2 has an inner diameter of 80 mm and a height of 40 mm, and the number of turns of the coil is 4. It is directly connected to the output port of the high-frequency induction heater 1 and screwed with bolts.

The high-frequency induction coil 2 has a hollow structure, which is communicated with the water cooling circulating guide in the high-frequency induction heater, so that the machine can be prevented from idling due to overheating of the equipment in the working process;

The high-frequency induction heat 1 is placed behind that hydraulic press 3, and an electric control device is arrange in the cabinet of the high-frequency induction heater 1, which can set heating time, heat preservation time, heating pow and heat preservation power, and control buttons and knobs are arranged on the surface of the cabinet; At the same time, the high-frequency induction heater is provided with an automatic mode and a manual mode, wherein the automatic mode is automatically operated according to the set heating time and holding time, and the manual mode is controlled by a foot switch.

### Example 8

An ultra-fast sintering system for preparing nano-ceramics with ultrasonic-assisted pressurization and high-frequency induction is described in Embodiment 7. The difference is that the ultrasonic generator 6 is placed on the upper floor of the base of the hydraulic lifting system, and the input end of the transducer is connected with the output end of the ultrasonic generator.

The ultrasonic generator rectifies and filters the power frequency alternating current of 220V and 50/60 Hz into a direct current of 310V, which is chopped into a specific high-frequency alternating current, and then the signal is amplified to several thousand volts of high-voltage alternating current to drive the transducer. The frequency of the transducer is 20˜28 kHz, and the power is 1200˜2000W. After receiving the current signal of the ultrasonic generator and generating resonance, the amplitude transformer connected with it amplifies the particle displacement or speed of mechanical vibration and concentrates the ultrasonic energy in a small area.

The transducer and the horn are in an integrated structure and are matched by bolts;

The bottom of the transducer is provided with a clamping device 5, which can adjust and fix the height of the transducer. Furthermore, the clamping device is sleeved on the transducer after the handle is installed through a ring-shaped sleeve, and the sleeve can be tightened by bolts, thereby fixing the position of the transducer.

### Example 9

The invention relates to a method for sintering and forming nano-ceramic powder based on an ultra-fast sintering system for preparing nano-ceramics by ultrasonic-assisted pressure coupling high-frequency induction, which comprises the following steps:
1) Dispersion of nano-powder: adding nano-ceramic powder into a beaker containing 200 ml absolute ethanol, ultrasonically dispersing and stirring for 30 min to obtain a uniformly dispersed solution, then taking cemented carbide balls with 10 times the mass of the mixture, pouring them into a ball milling tank, filling them with nitrogen, ball milling for 48 h, drying the ball milled solution in a vacuum drying oven at 120° C. for 24 h, and sieving with 200 meshes to obtain nano-powder for sintering;
2) Charging: sequentially placing a lower press head 14, nano powder and an upper press head 13 in a graphite mold, and placing graphite gaskets between the nano powder, the graphite mold and the inner surface of the press head to prevent the powder from leaking during the pressing process, and then placing the prepared sintering mold on the working platform of the middle cross beam;
3) Ultrasonic-assisted cold pressing: the computer controls the beam 9 in the hydraulic lifting system to rise to the position where the upper pressure head 13 just touches the upper beam 7, then installs the transducer and the horn, connects it with the ultrasonic generator and connects it with the power supply, finally passes through the cavity of the working platform, and fixes the horn to the position where it is in close contact with the lower pressure head with the clamping device; Start the ultrasonic vibration system, and set the force of 5˜10 MPa in the software for 1˜2 min. At this stage, ultrasonic vibration is used to promote the flow rearrangement of powder particles and exhaust the gas between particles; After the preloading time is over, gradually increase the pressure to the required value and then keep it constant; In this process, the pressure exerted by the beam is accurately controlled by software, and the computer can record the shrinkage displacement of sintered powder in real time.
4) Heating up: start the high-frequency induction heating system (power is set according to the sintered powder), heat up to the pre-sintering temperature (temperature is set according to the sintered powder), after the pre-sintering stage is completed, start the ultrasonic vibration system, set the frequency to 80%, and increase the high-frequency power to the specified value, so as to reach the final sintering temperature;
5) heat preservation: turning off the ultrasonic vibration system after reaching the final sintering temperature; Using the heat of graphite mold to promote the sintering of nano-ceramic grains, and realize the densification of nano-ceramic materials with the growth of grains;
6) cooling: after observing that the displacement curve in the software does not continue to rise, the high-frequency induction heating system is turned off to stop sintering, so that the graphite mold is naturally cooled to room temperature, and the sintered sample is taken out, and then the relevant mechanical properties are tested.

In the invention, the lower press head 14, the sintered powder and the upper press head 13 are sequentially placed in the graphite mold 11 and in the groove of the working platform 8 of the middle beam 9, and the groove and the mold are in clearance fit, so that the lateral displacement during the pressing process can be limited; The transducer and the horn 10 with integrated structure pass through the cavity of the working platform 8, and the top of the horn is in direct contact with the lower ram 14, which is fixed by the clamping device 5. The working platform 8 is used to transmit the pressing force generated by the middle beam 9 driven by the hydraulic press 3 and the upper beam 7 which prevents it from rising continuously during the pressing process. The computer software can control the force, and the displacement and pressure value changes during the pressing process are transmitted to the computer through the sensor 12. The curve changing with time can be generated by the supporting software for analysis. The input end of the ultrasonic transducer 10 is connected to the output end of the ultrasonic generator 6. The ultrasonic transducer 10 has a frequency of 20˜28 kHz and a power of 1200˜2000 W, and is controlled by the ultrasonic generator 6. The high-frequency induction heater 1 provides power for the high-frequency induction coil 2, the graphite mold 11 is placed in the high-frequency induction coil 2, and the graphite mold 11 is heated by the high-frequency induction coil 2 to achieve the purpose of primary sintering; During sintering, the temperature of the surface of graphite mold 11 was recorded by infrared thermometer 4.

The experiment was carried out according to the sintering method of Example 9. The sintering powder was Al₂O₃, the sintering temperature was 1400° C., and the sintering pressure was 30 MPa.

The sintering experiment was carried out twice: a: the ultrasonic system was not turned on; b: turn on the ultrasonic system, in which b is completely carried out according to Example 9, and a is used as the control group, and the ultrasonic system is not turned on in the heating stage, and other conditions are the same as Example 9;

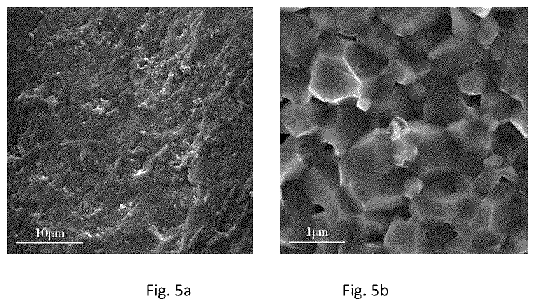

The standard tool samples of 3 mm×4 mm×15 mm were obtained by a and b, and then the relative density was measured by Archimedes drainage method, the bending strength was measured by three-point bending method, the Vickers hardness and toughness were measured by Vickers indentation method, and the microstructure of the sample section was observed by scanning electron microscope. The mechanical properties of tool samples a and b are shown in Table 1 below, and the microstructure is shown in FIG. 5.

TABLE 1
Mechanical properties

| | | Fracture | | |
|---|---|---|---|---|
| | | toughness/ | Flexural | Relative |
| sample | Hardness/GPa | MPa · m^{1/2} | strength/MPa | density/% |
| a | 9.45 ± 0.25 | 2.65 ± 0.10 | 180.83 ± 20.75 | 82.4 |
| b | 17.32 ± 0.48 | 4.18 ± 0.12 | 320.56 ± 28.56 | 98.6 |

From the comparison of mechanical properties in Table 1, it can be seen that the application of ultrasonic system can greatly improve the comprehensive mechanical properties of the tool during the heating or sintering process. Combined with the scanning electron microscope diagram of the tool sample in FIG. 5, it can be seen that the grain size of the sample subjected to ultrasonic vibration is relatively uniform, the number and area of pores are reduced, and the density distribution is more uniform and dense.

As shown in FIG. 5(a), during the sintering process, the ultrasonic wave was not turned on. It can be clearly seen from the cross section that the grain growth of Al₂O₃ was insufficient and no obvious grain boundary was formed, which was in sharp contrast with that of sample b. This phenomenon can be understood as that the application of ultrasonic vibration activated the powder surface, produced local thermal effect, reduced the resistance to plastic deformation, improved the plastic deformation degree of powder particles, and thus lowered the densification temperature.

The above is the preferred embodiment of the present invention, and it should be pointed out that a person skilled in the art can make several improvements and embellishments without departing from the principle of the present invention, and these improvements and embellishments should also be regarded as the protection scope of the present invention.

What is claimed is:

1. An ultra-fast sintering system for preparing nano-ceramics by ultrasonic-assisted pressurized coupling high-frequency induction comprising a high-frequency induction heating system, a hydraulic lifting system and an ultrasonic vibration system; the high-frequency induction heating system comprising a high-frequency induction coil and a high-frequency induction heating machine, and the high-frequency induction heating machine is connected with the high-frequency induction coil to provide power for the high-frequency induction coil;
wherein the hydraulic lifting system comprises a hydraulic press, upper beam and middle beam, the upper beam is fixed on the hydraulic press, the middle beam can be relative to the hydraulic press up and down, the middle beam is arranged on the working platform and sintering mold, hydraulic lifting system for the sintering mold processing workpiece to provide pressure, high frequency induction coil is arranged outside the sintering mold; and
the ultrasonic vibration system comprises an ultrasonic generator, a transducer and a amplitude converter for applying ultrasonic vibration in the sintering process.

2. The ultrasound-assisted pressure coupled high frequency induction for the preparation of nano-ceramics according to claim 1, wherein the sintering mold comprises an upper indenter, a lower indenter and an external graphite mold, and the upper indenter, the lower indenter and the graphite mold form a cavity for loading powder.

3. An ultrasound-assisted pressure coupling high frequency induction system for preparing nano-ceramics comprising a working platform that is a cylindrical hollow structure, the hollow structure is used to place an amplitude rod, the upper part of the working platform is provided with a groove, the graphite mold is placed in the groove, and the groove and the graphite mold are interstitial coordination which limits the transverse displacement of the graphite mold during the pressing process.

4. The ultrasound-assisted pressure coupled high-frequency induction system for preparing nano-ceramics according to claim 3, wherein the lower end of the transformer rod is connected with the ultrasonic transducer, which is an integrated structure; the transformer rod as a whole passes through the cavity in the middle of the working platform, and its upper end is in direct contact with the lower pressure head to ensure that the pulse pressure can be transmitted to the powder through the lower pressure head; the ultrasonic transducer and the amplitude lever are located directly below the working platform and the axis coincides with the axis of the sintering mold.

5. The ultrasound-assisted pressure coupled high-frequency induction system for preparing nano-ceramics according to claim 4, wherein the hydraulic lifting system is controlled by computer software, by controlling the lifting of the middle beam, adjusting the pressure, putting pressure on the mold, maintaining pressure and relieving pressure, and the powder between the upper head and the lower head is gradually densified by pressure; a sensor is arranged under the working platform, and the sensor is fixed on the middle beam by hexagonal bolts; the lower part of the working platform has a section of external thread, and the through hole in the middle beam has a section of internal thread, and the thread between the two is fixed; the interior of the sensor includes displacement sensor and pressure sensor, which are directly connected to the computer, and the changes of pressure and displacement can be recorded in real time through software.

6. The ultrasound-assisted pressure coupled high-frequency induction system for preparing nano-ceramics according to claim 5, wherein an infrared thermometer is arranged outside the sintering mold and connected to a computer to record the temperature of the surface of the sintering mold in real time.

7. The ultrasound-assisted pressure coupled high-frequency induction system for preparing nano-ceramics according to claim 6, wherein the input voltage of the high-frequency induction heating machine is 220V and the power is 0˜50 KW;
the inner diameter of the high-frequency induction coil is 80 mm, the height is 40 mm, the number of turns of the coil is 4, and the coil is directly connected to the output port of the high-frequency induction heater;
the high frequency induction coil has an inner hollow structure and is connected with the water cooling circulating guide inside the high frequency induction heating machine;
preferably, the high-frequency induction heater is placed behind the hydraulic press, and the high-frequency induction heater is provided in the chassis;
electronic control device, can set heating time, holding time and heating power, holding power, control keys and knobs are set on the surface of the chassis; at the same time, the high-frequency induction heating machine is set with automatic mode and manual mode, the automatic mode is automatically operated according to the set heating time and holding time, and the manual mode is controlled by the foot switch.

8. The ultrasound-assisted pressure coupled high-frequency induction system for preparing nano-ceramics according to claim 7, wherein the ultrasonic generator is placed on the upper base of the hydraulic lifting system, and the input end of the transducer is connected to the output end of the ultrasonic generator; the ultrasonic generator 220V, 50/60 Hz power frequency AC rectifier filter is converted into 310V direct current, after chopping into a specific high-frequency AC, and then the signal is amplified to several thousand volts of high-voltage AC to drive the transducer, so that resonance is generated on its own resonance point;
the frequency of the transducer is 20˜28 kHz, and the power is 1200˜2000W;
a clamping device is arranged at the bottom of the transducer, and the clamping device can adjust and fix the height of the transducer.

9. A method for sintering and forming nano-ceramic powders based on an ultra-fast sintering system for preparing nano-ceramics by ultrasound-assisted pressurized coupled high-frequency induction described in claim 8, comprising the following steps:
i) dispersion of nano-powders: nano-ceramic powder was added to a beaker containing 200 ml anhydrous ethanol, ultrasonic dispersion and stirring for 30 min, to obtain a uniformly dispersed solution; then, cemented carbide balls with 10 times the mass of the mixture were poured into a ball mill tank with the solution, filled with nitrogen, ball milling for 48 h, and the solution after ball milling was placed in a vacuum drying oven at 120° C. for 24 h; after 200 mesh sifting, the nano-powder used for sintering was obtained;
ii) loading: place the lower indenter, nano powder and upper indenter in turn in the graphite mold, and the graphite gasket is placed between the nano powder and the graphite mold and the inner surface of the indenter, and then place the prepared sintering mold on the working platform of the middle beam;
iii) ultrasonic assisted cold pressing: the beam in the computer-controlled hydraulic lifting system is raised to the position where the upper incompressor just touches the upper beam, and then the transducer and the amplitude transformer are installed, connected to the ultrasonic generator and connected to the power supply, and finally through the cavity of the working platform, and the amplitude transformer is fixed to the position in close contact with the lower incompressor with the clamping device; start the ultrasonic vibration system, set a force of 5˜10 MPa in the software to pre-press for 1˜2 min, and gradually increase the pressure to the required value after the end of the pre-pressure time, and then keep it constant; in this process, the pressure exerted by the beam is precisely controlled by the software, and the shrinkage displacement of the sintered powder is recorded by the computer in real time;
iv) temperature rise: turn on the high-frequency induction heating system, temperature rise to the pre-sintering temperature, after the pre-sintering stage is completed, turn on the ultrasonic vibration system, the frequency is set to 80%, and increase the high-frequency power to the specified value, so that the final sintering temperature can be reached;
v) insulation: after reaching the final sintering temperature, turn off the ultrasonic vibration system; the heating of graphite mold was used to promote the sintering of nano-ceramic grains, and the densification of nano-ceramic materials was realized along with the grain growth; and
vi) cooling: after observing that the displacement curve in the software does not continue to rise, turn off the high-frequency induction heating system to stop sintering, so that the graphite mold is cooled to room temperature naturally, and take out the sintering sample.
